(19) United States
(12) Patent Application Publication
(10) Pub. No.: US 2007/0137047 A1
(43) Pub. Date: Jun. 21, 2007

(54) Folding knife

(75) Inventor: Paul Y. Kim, Santa Ana, CA (US)

Correspondence Address: DAVID WEISS, 12650 RIVERSIDE DRIVE, SUITE 100, NORTH HOLLYWOOD, CA, 91607-3442, US

(73) Assignee: SUREFIRE, LLC, a California limited liability company

(21) Appl. No.: 11/303,178

(22) Filed: Dec. 15, 2005

(51) Int. Cl. B26B 1/04

(52) U.S. Cl. 30/161

(57) ABSTRACT

A folding knife including a knife blade pivotally secured to a knife handle in such manner as to permit the knife blade to be releasably locked in a closed position with respect to the handle and in practically any open position.

### BACKGROUND OF THE INVENTION

The present invention relates to knives and, more particularly, a hand-held folding knife which, in a preferred embodiment, can be locked in alternative blade orientations.

Knives have been used and carried as tools and weapons since the earliest times of human existence. As the art and craft of knife making has developed, folding knives have been created as an alternative to fixed bladed knives which require a sheath for safe transport and handling.

Modern examples of folding knives can be found in the recent patents to: Li Yu, U.S. Pat. No. 6,763,592 B2; Glesser, U.S. Pat. No. 6,751,868 B2; Cheng, U.S. Pat. No. 6,651,344 B2; Onion, U.S. Pat. No. 6,591,504 B2; Glesser, U.S. Pat. No. D461,387 S; Horn, U.S. Pat. No. Des. 387,966; and the publications of Chu, Pub. No. US 2004/0134075 A1 and Frazer, Pub. No. US 2003/0070299 A1. Each of these teaches a folding knife with various degrees of complexity.

Examples of folding knives that are capable of being locked while in a fully open position include patents to Pittman, U.S. Pat. No. 5,615,484; Centofante, U.S. Pat. No. 5,964,036; and Glesser et al., U.S. Pat. No. 6,553,672 B2.

What has been needed and which is supplied by the present invention, is a relatively simple folding knife with few parts and a simple, easily used mechanism for deploying the blade and for locking the blade in a fully open position, a fully closed position, and a plurality of partially open positions between the fully open and the fully closed positions.

### SUMMARY OF THE INVENTION

According to the present invention, a folding knife includes a knife blade pivotally secured to a knife handle in such manner as to permit the knife blade to be releasably locked in a closed position with respect to the handle and in practically any open position.

According to one aspect of the present invention, a folding knife comprises: a knife handle including a lug guide; a pivot lock carried by the knife handle, the pivot lock including a blade pivot and a lug for the lug guide; a knife blade having a tang including a pivot hole and two lug slots, the blade pivot received by the pivot hole for enabling rotation of the knife blade about the blade pivot when the lug is disengaged from the lug slots, the knife blade locked in an open position with respect to the knife handle when the lug engages one of the lug slots and in a closed position when the lug engages the other of the lug slots; and a pushbutton carried by the handle and coupled to the pivot lock, the pushbutton biased for normally engaging the lug with the lug slots and for disengaging the lug from the lug slots when the pushbutton is depressed. The knife handle preferably includes a spring biasing the pushbutton in a direction away from the pivot lock for normally engaging the lug with the lug slots, the pushbutton being depressible against the bias of the spring for disengaging the lug from the lug slots. The two lug slots are preferably spaced apart by 180 degrees about the pivot hole. The tang may include at least one additional lug slot for being engaged by the lug when the knife blade is in a partially open position, the at least one additional lug slot preferably spaced from the two lug slots about the pivot hole.

A preferred embodiment of a folding knife according to the present invention comprises: a knife handle including two lug guides; a pivot lock carried by the knife handle, the pivot lock including a blade pivot and two lugs for the lug guides; a knife blade having a tang including a pivot hole and two lug slots spaced about the pivot hole, the blade pivot received by the pivot hole for enabling rotation of the knife blade about the blade pivot when the lugs are disengaged from the lug slots, the knife blade locked in an open position with respect to the knife handle when one of the lugs engages one of the lug slots and the other of the lugs engages the other of the lug slots, the knife blade locked in a closed position when such one of the lugs engages such other of the lug slots and such other of the lugs engages such one of the lug slots; and a pushbutton carried by the handle and coupled to the pivot lock, the pushbutton biased for normally engaging the lugs with the lug slots and for disengaging the lugs from the lug slots when the pushbutton is depressed. The knife preferably includes a spring biasing the pushbutton in a direction away from the pivot lock for normally engaging the lugs with the lug slots, the pushbutton being depressible against the bias of the spring for disengaging the lugs from the slots.

The two lug slots are preferably spaced apart by 180 degrees about the pivot hole. The tang may include at least one pair of additional lug slots spaced about the pivot hole for being engaged by the lugs when the knife blade is in at least one predetermined partially open position with respect to the knife handle. The lug slots of each of the at least one pair of additional lug slots are preferably spaced apart by 180 degrees.

The knife handle preferably includes an elongate first scale including the lug guide, and an elongate second scale secured to the first scale and laterally spaced therefrom for accommodating the knife blade between the first scale and the second scale; the pivot lock is carried by the first scale; and the pushbutton is carried by the second scale.

Depressing the pushbutton moves the lugs out of engagement with the lug slots, permitting the blade to rotate on the blade pivot. When the blade is in a desired orientation, as determined by aligning the lugs with the desired lug slots, the pushbutton is released and, under the bias of the spring, the lugs engage the lug slots, holding the blade in the selected orientation. Throughout pushbutton operation, the lugs move within, but are never free of, the lug guides in the first scale.

The lug slots are typically arranged in opposed pairs that correspond to an opposed pair of lugs. The lug slots can be varied in number and can be further varied in their location around the blade's pivot hole. In one configuration, four pairs of opposed lug slots may be located about the pivot hole with the slots of one pair being at 0 and 180 degrees, respectively (i.e., substantially along the knife's longitudinal axis, for fully open or closed blade positions), the slots of the second pair at 45 and 225 degrees (for a partially open position), the slots of the third pair at 90 and 270 degrees (for another partially open position), and the slots of the fourth pair at 135 and 315 degrees (for yet another partially open position). The lug slots can be located in any other location around the pivot hole. The pivot lock is operable with one or more lugs.

Accordingly, an object of this invention is to provide a simple folding knife that is easily manufactured and assembled. An additional object of this invention is to provide a folding knife that is easily deployed. It is a further object of this invention to have a folding knife with a blade that can be releasably locked in a closed position and in at least one open position of practically any degree of openness.

### BRIEF DESCRIPTION OF THE DRAWINGS

The novel features which are characteristic of the invention, both as to structure and method of operation thereof, together with further objects and advantages thereof, will be understood from the following description, considered in connection with the accompanying drawings, in which a preferred embodiment of the invention is illustrated by way of example. It is to be expressly understood, however, that the drawing is for the purpose of illustration and description only, and is not intended as a definition of the limits of the invention.

FIG. 1 is an exploded perspective view of a preferred embodiment of a folding knife in accordance with the instant invention;

FIG. 2 is a front side view of the assembled knife embodiment of FIG. 1; and

FIG. 3 is a magnified cross-sectional view of a portion of the knife of FIG. 2 taken along the line 3-3 in the direction of the appended arrows.

### DETAILED DESCRIPTION OF THE PREFERRED EMBODIMENT

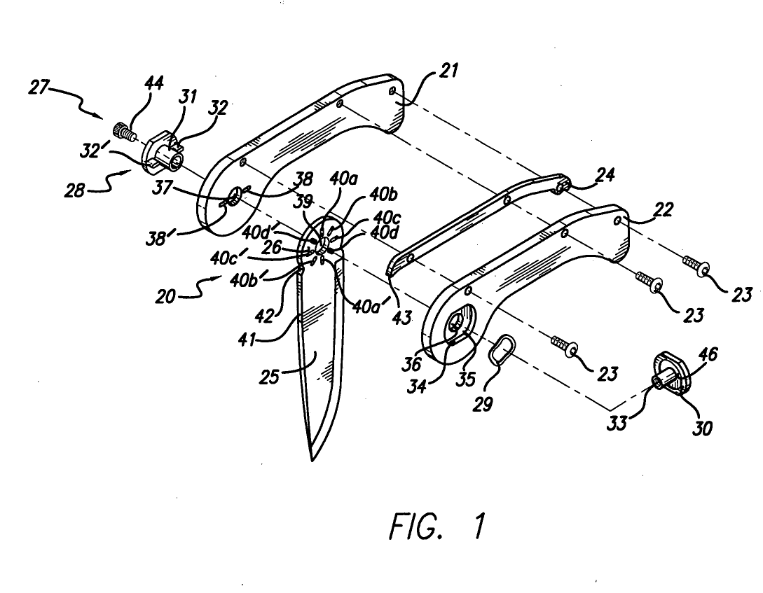

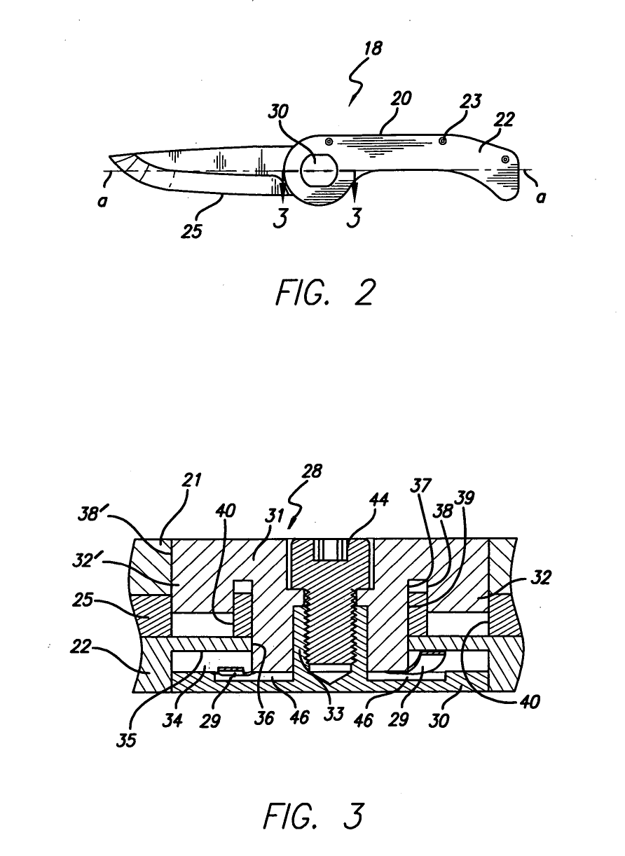

FIGS. 1-3 illustrate a typical preferred embodiment of a folding knife 18 of the instant invention. A knife handle 20 includes an elongate rear scale 21 attached to an elongate front scale 22, such as by screws 23, although rivets or other means could be employed to fasten the parts together. A spacer 24 between the rear scale 21 and the front scale 22 holds the rear scale 21 and front scale 22 at a fixed lateral distance and position with respect to one another sufficient to accommodate a knife blade 25 having a tang 26. In this manner, the width of the spacer 24 controls the amount of friction or pressure applied to the tang 26 by the rear scale 21 and the front scale 22.

The rear scale 21, spacer 24, front scale 22, and tang 26 are configured to collectively accommodate a lug assembly 27 that allows a user to lock the blade 25 of the knife in a closed position and in a plurality of open positions, including a fully open position and at least one partially open position where the knife blade 25 is rotated to a position other than a fully open position. The lug assembly 27 comprises a pivot lock 28, a spring 29, and a pushbutton 30. The pivot lock 28 further comprises a blade pivot 31 and, as shown, a pair of lugs 32, 32′. The pushbutton 30 further includes a pivot retainer 33 and a spring cavity 46. The spring cavity 46 is best seen in FIG. 3.

The front scale 22 has a spring well 34 that further comprises a spring seat 35 and a front pivot hole 36. The spring 29 resides in the spring well 34 and is located between the spring seat 35 and the spring cavity 46 of the pushbutton 30. As can be seen in FIG. 3, the pivot retainer 33 passes through the front pivot hole 36 and is attached to the pivot lock 28 by a screw 44 or other means.

The rear scale 21 has a hole 37 therethrough in which the blade pivot 31 resides. One or more lug guides 38 extend through the rear scale 21 near the rear scale hole 37 and are configured in location and number to receive the lugs 32. The blade 25 has a pivot hole 39 in its tang 26 that allows the blade 25 to rotate on the blade pivot 31. The tang 26 also has one or more lug slots 40 around the pivot hole 39. The blade pivot 31 passes through the rear scale hole 37 and through the pivot hole 39 in the tang 26. The blade pivot 31 is sufficiently long so that when the pushbutton 30 is fully depressed along the pivot axis against the bias of the spring 29, fully displacing the lugs 32 from the lug slots 40 in the tang 26, the blade pivot 31 remains within the blade's pivot hole 39. The lugs 32 are of a length such that they are fully removed from the lug slots 40 but are still within the lug guides 38 when the pushbutton is fully depressed.

In normal operation, the spring 29 outwardly biases the pushbutton 30 to correspondingly urge the attached pivot lock 28 to maintain the lugs 32 in engagement with the lug slots 40, locking the blade 25 against rotation. A user fully depressing the pushbutton 30 against the bias of the spring 29 correspondingly moves the attached pivot lock 28 to disengage the lugs 32 from the lug slots 40. In this state, the blade 25 is free to rotate about the blade pivot 31 and can be rotated to a closed position or to an open position as selected by the user, whereupon the user releases the pushbutton 30 to lock the blade 25 in the selected position.

The embodiment shown allows a typical operation wherein two lugs 32-32′ collectively and simultaneously engage any one of four different pairs of lug slots 40a-a′, 40b-b′, 40c-c′ or 40d-d′. In the illustrated example, the two lugs 32-32′ are radially directed about the rear scale hole 37, substantially along the longitudinal axis a of the knife 18, and are rotationally spaced apart by 180 degrees. Each of the slots 40 through the tang 26 are radially directed about the pivot hole 39, and the slots 40 of each pair of slots are spaced apart by 180 degrees for receiving the two lugs 32-32′. The pairs of slots 40 may be uniformly rotationally spaced about the pivot hole 39; in the illustrated example of four slot pairs, the successive slot pairs may be separated by 45 degrees.

One of the slot pairs (e.g. slot 40a and 40a′) is oriented with respect to the lug guides 38 and 38′ (which are in correspondence with the lugs 32 and 32′, respectively) such that the blade 25 is in its fully open position (substantially along the knife's longitudinal axis a) when the blade 25 has been rotated with lug 32 received by slot 40a and lug 32′ received by slot 40a′, and the blade 25 is in its closed position (also substantially along the knife's longitudinal axis a) when the blade 25 has been rotated with lug 32 received by slot 40a′ and lug 32′ received by slot 40a.

Similarly, the blade 25 is open 45 degrees from the closed position when lugs 32 and 32′ engage, respectively, lug slots 40d and 40d′, the blade 25 is open 90 degrees from the closed position when lugs 32 and 32′ engage, respectively, lug slots 40c and 40c′, and the blade 25 is open 135 degrees from the closed position when lugs 32 and 32′ engage, respectively, lug slots 40b and 40b′. The number and location of the lugs 32, lug guides 38, and lug slots 40 can all be varied so that practically any degree of open position can be obtained. The folding knife can be fully operational with one or more lugs 32 engaging one or more lug slots 40.

The blade 25 has a back edge 41 and a stop notch 42 between the back edge 41 and the tang 26. When the blade 25 is rotated to a fully open position 180 degrees from the closed position, the stop notch 42 makes contact with a stop tip 43 on the spacer 24. This contact prevents the blade from rotating beyond the fully open position. If the blade is to rotate more than 180 degrees beyond the closed position, the stop notch 42, or stop tip 43, or both may be omitted from the structure.

The disclosed knife embodiment and its various components may be manufactured using fabrication methods and of materials well known in the art. For example, the knife blade is preferably fabricated of steel, and the scales and other components may be fabricated of metallic materials such as steel, titanium or aluminum alloys, or of polymeric materials. If desired, a single-piece knife handle including the scales and spacer may be made by milling a single piece of stock, by forming it from a mold, or by other means known in the art.

The foregoing description is for illustrative purposes only. It will be apparent to those skilled in the art that various changes and modifications can be made to the instant invention without departing from the overall spirit and scope of the instant invention. It is in that context that the following claims are made.

What I claim as my invention is:

1. A folding knife comprising:
a knife handle including a lug guide;
a pivot lock carried by said knife handle, said pivot lock including a blade pivot and a lug for said lug guide;
a knife blade having a tang including a pivot hole and two lug slots, said blade pivot received by said pivot hole for enabling rotation of said knife blade about said blade pivot when said lug is disengaged from said lug slots, said knife blade locked in an open position with respect to said knife handle when said lug engages one of said lug slots and in a closed position when said lug engages the other of said lug slots; and
a pushbutton carried by said knife handle and coupled to said pivot lock, said pushbutton biased for normally engaging said lug with said lug slots and for disengaging said lug from said lug slots when said pushbutton is depressed.

2. The knife according to claim 1, including:
a spring biasing said pushbutton in a direction away from said pivot lock for normally engaging said lug with said lug slots, said pushbutton being depressible against the bias of said spring for disengaging said lug from said lug slots.

3. The knife according to claim 1, wherein:
said lug slots are spaced apart by 180 degrees about said pivot hole.

4. The knife according to claim 1, wherein:
said tang includes at least one additional lug slot for being engaged by said lug when said knife blade is in a partially open position.

5. The knife according to claim 4, wherein:
said at least one additional slot is spaced from said two lug slots about said pivot hole.

6. The knife according to claim 1, wherein:
said knife handle includes a stop adapted to cooperate with said knife blade for preventing rotation of said knife blade past said open position.

7. The knife according to Claim 1, wherein:
said knife handle includes an elongate first scale including said lug guide, and an elongate second scale secured to said first scale and laterally spaced therefrom for accommodating said knife blade between said first scale and said second scale;
said pivot lock is carried by said first scale; and
said pushbutton is carried by said second scale.

8. A folding knife comprising:
a knife handle including two lug guides;
a pivot lock carried by said knife handle, said pivot lock including a blade pivot and two lugs for said lug guides;
a knife blade having a tang including a pivot hole and two lug slots spaced about said pivot hole, said blade pivot received by said pivot hole for enabling rotation of said knife blade about said blade pivot when said lugs are disengaged from said lug slots, said knife blade locked in an open position with respect to said knife handle when one of said lugs engages one of said lug slots and the other of said lugs engages the other of said lug slots, said knife blade locked in a closed position when said one of said lugs engages said other of said lug slots and said other of said lugs engages said one of said lug slots; and
a pushbutton carried by said knife handle and coupled to said pivot lock, said pushbutton biased for normally engaging said lugs with said lug slots and for disengaging said lugs from said lug slots when said pushbutton is depressed.

9. The knife according to claim 8, including:
a spring biasing said pushbutton in a direction away from said pivot lock for normally engaging said lugs with said lug slots, said pushbutton being depressible against the bias of said spring for disengaging said lugs from said slots.

10. The knife according to claim 8, wherein:
said lug slots are spaced apart by 180 degrees about said pivot hole.

11. The knife according to claim 8, wherein:
said tang includes at least one pair of additional lug slots spaced about said pivot hole for being engaged by said lugs when said knife blade is in at least one predetermined partially open position with respect to said knife handle.

12. The knife according to claim 11, wherein:
the lug slots of each of said at least one pair of additional lug slots are spaced apart by 180 degrees.

13. The knife according to claim 12, wherein:
said two lug slots are spaced apart by 180 degrees about said pivot hole.

14. The knife according to claim 8, wherein:
said knife handle includes a stop adapted to cooperate with said knife blade for preventing rotation of said knife blade past said open position.

15. The knife according to Claim 8, wherein:
said knife handle includes an elongate first scale including said lug guide, and an elongate second scale secured to said first scale and laterally spaced therefrom for accommodating said knife blade between said first scale and said second scale;
said pivot lock is carried by said first scale; and
said pushbutton is carried by said second scale.
